(19) United States
(12) Patent Application Publication
(10) Pub. No.: US 2005/0145663 A1
(43) Pub. Date: Jul. 7, 2005

(54) Detachable modular fishing belt

(76) Inventor: Chris Samuels, Mammoth Lakes, CA (US)

Correspondence Address: TOPE-MCKAY & ASSOCIATES, 23852 PACIFIC COAST HIGHWAY #311, MALIBU, CA, 90265, US

(21) Appl. No.: 10/979,791

(22) Filed: Nov. 1, 2004

Related U.S. Application Data
(60) Provisional application No. 60/516,031, filed on Oct. 30, 2003.

(51) Int. Cl. A01K 97/10; A45C 1/04; F41C 33/02; F42B 39/02

(52) U.S. Cl. 224/575; 224/580; 224/200; 224/665

(57) ABSTRACT

The present invention provides a detachable, modular fishing belt that is suited for a plethora of fishing tasks. More specifically, the invention provides for a detachable, modular fishing belt for attaching a variety of items including front and side plates, suspenders for additional support to a user, and a variety of tools to aid in fishing. The belt also provides for rapid attachment and detachment of the plates and other tools to quickly aid the user during the process of catching a fish. The belt also includes multiple compartments and straps to store different fishing accessories, including tools, tag clips, and towels.

### PRIORITY CLAIM

The present application claims the benefit of priority of U.S. Provisional Patent Application No. 60/516,031, filed Oct. 30, 2003, entitled “Modular Fishing Belt.”

### BACKGROUND OF THE INVENTION

(1) Technical Field

The present invention relates to the field of saltwater fishing belts, harnesses, and back braces for supporting a fishing pole. More particularly, the present invention provides a detachable, modular fishing belt that permits rapid exchange of various pressure distribution plates, containers, and other accessories to enable a deep sea fisherman to rapidly adapt the belt for use in a fast-paced fishing environment.

(2) Discussion

Professional deep sea fishing presents a challenge and test of skill and strength for a fisherman, particularly when catching large game fish using stand-up fishing methods. In stand-up fishing, a fisherman uses a shorter rod with a fishing belt and a waist band. Stand-up fishing is typically used with game fish ranging in size from 20 to 400 pounds. Game fish in this size range can fight a fisherman for up to several hours, requiring a fisherman with considerable experience and endurance, as well as proper gear.

Examples of prior art fishing belts are represented by U.S. Pat. No. 4,828,152 to Pepping (the Pepping patent); U.S. Pat. No. 2,139,188 to Haislip (the Haislip patent); U.S. Pat. No. 2,271,136 to Geiger (the Geiger patent); U.S. Pat. No. 2,576,624 to Miller et al. (the Miller patent); U.S. Pat. No. 4,323,181 to Spasoff (the Spasoff patent); and U.S. Pat. No. 4,858,364 to Butts (the Butts patent).

In the Pepping patent, a fishing harness and rod belt holder for large game fishing is taught for distributing pressure from a fishing rod about one's kidneys and thighs by means of a rear kidney support and a front plate. The belt comprises a belt portion that supports a front plate across a user's thighs, and also includes a kidney support that extends from the belt against the kidney area of a user to assist in the distribution of pressure. Although the belt system of the Pepping patent aids in pressure distribution about the lower back, lower back pressure still remains. Further, the belt designed by the Pepping patent is only designed for holding a fishing rod in a frontal position, while a fishing line is extended for a catch. Thus, the invention of Pepping lacks modularity and is not well-suited for adaptation to a variety of fishing tasks.

The Haislip patent provides a fishing rod holder with a front plate having an adjustable height and direction. It is designed to be foldable and to fit on a small belt about one's waist. Because of its size and relatively weak overall structure, the belt of the Haislip patent is not well suited for ocean fishing, particularly for large fish. Further, the device of the Haislip patent is neither modular, nor would it distribute pressure in a manner that would protect the user from injury when tackling larger game fish.

The Geiger patent teaches a fisherman's rig including a full back support with safety straps and a rod socket. The rig in the invention of Geiger includes a single leather-covered metal plate to which various rod sockets may be attached. Aside from the rod socket, the invention of Geiger is neither modular, nor is it a true fishing belt. Rather, it is a harness designed for supporting a rod solely in front of a user.

The Miller patent et al. provides a plate with a pole holder, where the plate includes a set of bearings and arms to allow for pivotal (angular) adjustment of the pole. The plate may be attached to a standard waist belt or to a pole or other fixed portion of a boat in order to simplify fishing. Although not stated in the Miller patent, the plate presented appears to be most suitable for fresh water, or small ocean, game fishing, due both to its relatively small size and construction as well as the fact that it is designed for use with a simple waist belt. Further, the plate holder of Miller is not modular and does not comprise a fishing belt system.

The Spasoff teaches a simple, non-adjustable and non-modular pole support and bait storage device for attachment to a standard waist belt. Like the plate of the Miller patent, the pole support and bait storage device by Spasoff is likely suitable mainly for freshwater fishing, is not modular, and does not comprise a fishing belt system.

The Butts patent provides a thigh-wrap style fishing pole support with a lower back harness. Although tailored for stand-up large game fishing, the harness of Butts is not modular in design and simply provides a front rod support plate. Further, the design of the plate of Butts is such that it prevents separation of one's legs, which could conceivably narrow one's support base, allowing a strong pull by a fish to throw a user off-balance, creating a potentially dangerous situation for the user.

Although each of the above-discussed patents provides a solution to various needs of a fisherman, none provides a modular fishing belt that allows for rapid reconfiguration. In particular, none of the above-mentioned devices provide for both multiple-sized front-mounted and a single right or left-mounted plate, nor do they permit the detachable attachment of shoulder straps and kidney brace to allow for load adjustment. Further, none of the above-mentioned patents provide for the detachable attachment of a variety of tools and/or storage containers.

As will be more clearly demonstrated below, the present invention solves these problems by providing a rapidly reconfigurable modular fishing belt that allows for the interchange of a variety of plates and straps as well as a variety of tools and storage compartments.

### SUMMARY OF THE INVENTION

The present invention provides a detachable, modular fishing belt that is suited for a plethora of fishing tasks. More specifically, the invention provides for a detachable, modular fishing belt for attaching a variety of items including front and side plates, suspenders for additional support to a user, and a variety of tools to aid in fishing. The belt also provides for rapid attachment and detachment of the plates and other tools to quickly aid the user during the process of catching a fish. The belt also includes multiple compartments and straps to store different fishing accessories, including tools, tag clips, and towels.

In one embodiment of the present invention, a modular fishing belt for large game fishing comprises a belt portion for wrapping around a user's waist, the belt portion including a first end and a second end; where the belt includes an exterior portion, facing away from the user's body when the belt is secured, and an interior portion, facing toward the user's body when the belt is secured; a means for fastening the first end to the second end to securely hold the belt about a user's waist; a means for detachably attaching any type of front plate to allow a user to exchange different front plates to adjust for different fishing tasks, the front plate being attached to the exterior portion of the belt and positioned such that a user can rest a fishing pole in the front plate to distribute pressure therefrom about the user's thigh area; and a means for detachably attaching any type of side plate to allow a user to exchange different front plates to adjust for different fishing tasks, the side plate being attached to the exterior portion of the belt and positioned such that a user can rest a fishing pole in the side plate to distribute pressure therefrom about the user's hip area.

In another embodiment, a modular fishing belt includes a means for fastening the first end of the belt to the second end of the belt, the means for fastening selected from the group consisting of a standard side release clip, D-ring, snap, hook, button, or Velcro™.

In yet another embodiment, a modular fishing belt, wherein the means for detachably attaching a front plate to the belt is selected from the group consisting of a standard side release clip, D-ring, snap, hook, button, or Velcro™.

In a further embodiment, a modular fishing belt, wherein the means for detachably attaching a side plate to the belt is selected from the group consisting of a standard side release clip, D-ring, snap, hook, button, or Velcro™.

In a still further embodiment, a modular fishing belt, further comprising a means for detachably attaching a set of suspenders to the belt to rest over the shoulders and back of the user to assist in distributing pressure on the belt from the user's waist to the user's shoulders and back.

In a yet further embodiment, a modular fishing belt, wherein the means for detachably attaching a set of suspenders to the belt is selected from the group consisting of a standard side release clip, D-ring, snap, hook, button, or Velcro™.

In another embodiment, a modular fishing belt, further comprising a storage compartment having an upper end with an opening, the storage compartment attached to the exterior portion of the belt.

In another embodiment, a modular fishing belt, further comprising a means for detachably attaching a storage compartment to the belt.

In another embodiment, a modular fishing belt, wherein the means for detachably attaching a storage compartment to the belt is selected from the group consisting of a standard side release clip, snap, hook, button, or Velcro™.

In another embodiment, a modular fishing belt, further comprising a substantially rigid gasket shaped to fit securely in the storage compartment.

In another embodiment, a modular fishing belt, wherein the gasket is made of aluminum.

In another embodiment, a modular fishing belt, further comprising a substantially rigid cylindrical member for placement in said gasket for storing individual items, the cylindrical member having a closure for sealing individual items in the cylindrical member.

In another embodiment, a modular fishing belt, further comprising at least one malleable slab made of silicon shaped to fit snugly in the gasket, the slab having spaces therein to snugly secure the cylindrical member such that the silicon slab prevents substantial movement of the cylindrical member with respect to the gasket.

In another embodiment, a modular fishing belt, further comprising at least one tool compartment detachably attachable with the exterior portion of the belt and having an opening with a closure mechanism, the tool compartment configured to hold a hand tool.

In another embodiment, a modular fishing belt, further comprising a means for detachably attaching the tool compartment with the exterior portion of the belt.

In another embodiment, a modular fishing belt, wherein the means for attaching the tool compartment to the exterior of the belt is selected from the group consisting of a standard side release clip, belt clip, snap, hook, button, or Velcro™.

In another embodiment, a modular fishing belt, further comprising, on the exterior portion of the belt, a means for attaching and detaching a towel to said modular fishing belt.

In another embodiment, a modular fishing belt, wherein the means for attaching and detaching a towel to the fishing belt is selected from the group consisting of a standard side release clip, belt clip, snap, hook, button, or Velcro™.

In another embodiment, a modular fishing belt, further comprising, on the exterior portion of the belt, a means for attaching and detaching identification tags to the belt, to be placed on a fish.

In another embodiment, a modular fishing belt, wherein the means for attaching and detaching identification tags to the belt is selected from the group consisting of a clip, pin, snap, hook, or Velcro™.

In another embodiment, a modular fishing belt, where the belt further comprises an interior portion, a top rim, and a bottom rim, the belt having a strip of material passed in the interior portion from the first end to the second end in a zig-zag manner alternating from about the top rim to the bottom rim, whereby the strip of material provides additional support for the belt.

In another embodiment, a modular fishing belt for large game fishing, the belt comprising:
a belt portion for wrapping around a user's waist, the belt portion including a first end and a second end; where the belt includes an exterior portion, facing away from the user's body when the belt is secured, and an interior portion, facing toward the user's body when the belt is secured;
a fastener for fastening the first end to the second end to securely hold the belt about a user's waist;
a fastener for detachably attaching any type of front plate to allow a user to exchange different front plates to adjust for different fishing tasks, the front plate being attached to the exterior portion of the belt and positioned such that a user can rest a fishing pole in the front plate to distribute pressure therefrom about the user's thigh area; and
a fastener for detachably attaching any type of side plate to allow a user to exchange different front plates to adjust for different fishing tasks, the side plate being attached to the exterior portion of the belt and positioned such that a user can rest a fishing pole in the side plate to distribute pressure therefrom about the user's hip area.

In another embodiment, a modular fishing belt, wherein the fastener for fastening the first end of the belt to the second end of the belt is selected from the group consisting of a standard side release clip, D-ring, snap, hook, button, or Velcro™.

In another embodiment, a modular fishing belt, wherein the fastener for detachably attaching a front plate to the belt is selected from the group consisting of a standard side release clip, D-ring, snap, hook, button, or Velcro™.

In another embodiment, a modular fishing belt, wherein the fastener for detachably attaching a side plate to the belt is selected from the group consisting of a standard side release clip, D-ring, snap, hook, button, or Velcro™.

In another embodiment, a modular fishing belt, further comprising a fastener for detachably attaching a set of suspenders to the belt to rest over the shoulders and back of the user to assist in distributing pressure on the belt from the user's waist to the user's shoulders and back.

In another embodiment, a modular fishing belt, wherein the fastener for detachably attaching a set of suspenders to the belt is selected from the group consisting of a standard side release clip, D-ring, snap, hook, button, or Velcro™.

In another embodiment, a modular fishing belt, further comprising a storage compartment having an upper end with an opening, the storage compartment attached to the exterior portion of the belt.

In another embodiment, a modular fishing belt, further comprising a fastener for detachably attaching a storage compartment to the belt.

In another embodiment, a modular fishing belt, wherein the fastener for detachably attaching a storage compartment to the belt is selected from the group consisting of a standard side release clip, snap, hook, button, or Velcro™.

In another embodiment, a modular fishing belt, further comprising a substantially rigid gasket shaped to fit securely in the storage compartment.

In another embodiment, a modular fishing belt, wherein the gasket is made of aluminum.

In another embodiment, a modular fishing belt, further comprising a substantially rigid cylindrical member for placement in said gasket for storing individual items, the cylindrical member having a closure for sealing individual items in the cylindrical member.

In another embodiment, a modular fishing belt, further comprising at least one malleable slab made of silicon shaped to fit snugly in the gasket, the slab having spaces therein to snugly secure the cylindrical member such that the silicon slab prevents substantial movement of the cylindrical member with respect to the gasket.

In another embodiment, a modular fishing belt, further comprising at least one tool compartment detachably attachable with the exterior portion of the belt and having an opening with a closure mechanism, the tool compartment configured to hold a hand tool.

In another embodiment, a modular fishing belt, further comprising a fastener for detachably attaching the tool compartment with the exterior portion of the belt.

In another embodiment, a modular fishing belt, wherein the fastener for attaching the tool compartment to the exterior of the belt is selected from the group consisting of a standard side release clip, belt clip, snap, hook, button, or Velcro™.

In another embodiment, a modular fishing belt, further comprising, on the exterior portion of the belt, a means for attaching and detaching a towel to said modular fishing belt.

In another embodiment, a modular fishing belt, wherein the fastener for attaching and detaching a towel to the fishing belt is selected from the group consisting of a standard side release clip, belt clip, snap, hook, button, or Velcro™.

In another embodiment, a modular fishing belt further comprising, on the exterior portion of the belt, a fastener for attaching and detaching identification tags to the belt, to be placed on a fish.

In another embodiment, a modular fishing belt, wherein the fastener for attaching and detaching identification tags to the belt is selected from the group consisting of a clip, pin, snap, hook, or Velcro™.

In another embodiment, a modular fishing belt, where the belt further comprises an interior portion, a top rim, and a bottom rim, the belt having a strip of material passed in the interior portion from the first end to the second end in a zig-zag manner alternating from about the top rim to the bottom rim, whereby the strip of material provides additional support for the belt.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a front view of the exterior of one embodiment of a modular fishing belt according to the present invention;

FIG. 2 is an illustration of one embodiment of a front plate and a side plate to attach to the modular fishing belt;

FIG. 3 is a detail front view of one embodiment of one side of the modular fishing belt, containing a tool compartment and a tag clip;

FIG. 4A is a detail front view of one embodiment of one side of the modular fishing belt, containing a storage compartment and towel holder;

FIG. 4B is a detail view of one embodiment of the tool compartment, depicting side release clips to attach the tool compartment to the modular fishing belt; and

FIG. 4C is a detail view of one embodiment of a gasket and cylindrical container, which are placed within the tool compartment of the modular fishing belt.

### DETAILED DESCRIPTION

The present invention relates to the field of fishing belts and harnesses for supporting a fishing pole. More particularly, the present invention provides a modular fishing belt that permits rapid exchange of various pressure distribution plates, containers, and other accessories to enable a deep sea fisherman to rapidly adapt the belt for use in a fast-paced fishing environment. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein, may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

(1) Introduction

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

(2) Details

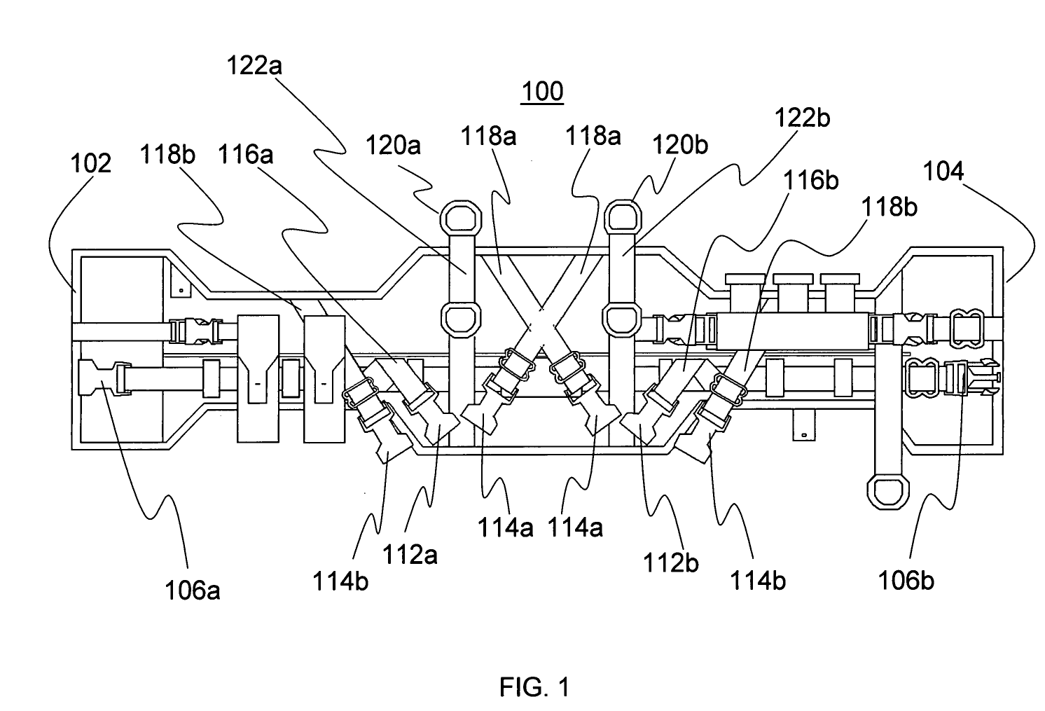

Reference is now made to one embodiment of the present invention, as shown in FIG. 1. A modular fishing belt 100 according to the present invention is shown, which is configured to encircle a human waist. The belt 100 includes a first end 102 and a second end 104, where the first end 102 and the second end 104 include a clip 106a and 106b for securing the first end 102 and the second end 104 around a user's waist. The clip 106a and 106b may be any known fastener, non-limiting examples including toothed release clips, standard size release clips, snaps, hooks, buttons, and Velcro™, or any combination of standard fastening devices.

The belt 100 includes an exterior portion 108 and an interior portion 110, where the exterior portion 108 is exposed and the interior portion 110 resides against a person's body when the belt 100 is worn. In one embodiment, the belt 100 further comprises an interior belt strap (not shown) running through the interior portion of the belt 100 to assist in the adjustability and in the support provided by the belt 100 by allowing the user to tighten or loosen the belt 100 around the user's waist.

The interior portion of the belt can be filled with any desired supporting material, such as webbing, to add back support. The supporting material may be configured in any desired manner to provide a desired back support pressure distribution profile and to assist in relieving strain on the legs of a fisherman.

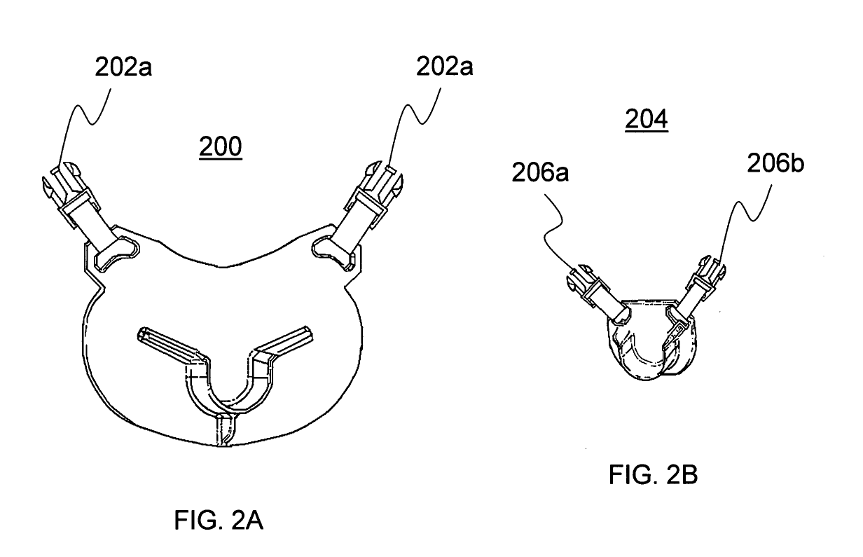

In one embodiment, the belt 100 includes a front plate attachment 112a and 112b to attach a front plate 200 (as shown in FIG. 2A), illustrated in the present embodiment as a pair of front plate clips 112a and 112b. The clips 112a and 112b may comprise any suitable attaching mechanism, non-limiting examples including quick-release clips, standard size release clips, doubled D-Ring braking systems, tie strings, and carabineer style clips. Front plate straps 116a and 116b on the belt 100 attach the belt 100 to the front plate 200 via the front plate clips 112a and 112b. The desirable features of the clips 112a and 112b are that it be sufficiently secure to withstand the amount of pressure exerted by a fish on a fishing rod to be captured, and that it allow for rapid release so that a fisherman can quickly exchange different front plates suited to different fishing tasks.

In one embodiment, the front plate clips 112a and 112b are doubled D-Ring braking mechanisms, which provide sufficient strength to secure the front plate and withstand the amount of pressure exerted by a fish on the fishing rod and front plate. Additionally, the D-Ring braking mechanism provides for rapid release, so that a fisherman can quickly exchange different sized front plates suited to different tasks. In one embodiment, the D-Ring braking mechanism uses one inch webbing straps attached to the front plate, which pass through the rings to form a resistance and “braking” mechanism to prevent the straps from moving.

In a further embodiment, the front plate 200 in FIG. 2A may also comprise a layer of padding behind the plate to provide for additional comfort to the user. Non-limiting examples of the padding may include urethane or silicone.

The belt 100 further includes side plate attachment clips 114a and 114b to attach a side plate 204 (as shown in FIG. 2B) to either the left or right side of the belt, depicted as a pair of side plate clips 114a and 114b. The side plate 204 is provided so that when a fisherman brings a fish close to a boat, he can move the fishing pole to a different leverage point in order to hoist the fish out of the water and into a net or into the boat. As with the front plate clips 112a and 112b, the means for detachably attaching a side plate 204 may comprise any suitable attaching mechanism, non-limiting examples including quick-release clips, standard size release clips, tie strings, and carbiner style clips. Also, the desirable features of the side plate clips 114a and 114b are that they be sufficiently secure to withstand the amount of pressure exerted by the fish to be captured, and that it allow for rapid release so that a fisherman can quickly exchange different side plates suited to different fishing tasks.

The belt further provides a front and side plate attachment 116a and 116b for any front or side plate that a fisherman needs. Two front plate belt straps, 116a and 116b, which lie along the fisherman's legs, are attached to the exterior of the belt 108. The two front plate belt straps 116a and 116b are attached to a front plate 200 by the front plate clips 112a and 112b, as illustrated in FIG. 2. The front plate 200 contains front plate clips 202a and 202b which attach to the front plate clips 112a and 112b on the belt 100. A side plate 204 connects with the belt 100 via side plate clips 206a and 206b on the side plate 204. Side plate straps 118a and 118b on the belt 100 attach the belt 100 to the side plate 204 via the side plate clips 114a and 114b. In one aspect of the present embodiment, the front plate clips 202a and 202b and side plate clips 206a and 206b are all standard side release clips. The plates also contain slide-prevention devices to prevent the fishing pole from sliding off of the plate.

If a fishing rod is being supported on a front plate while large game fishing, a fisherman needs suspenders to hold the belt about the waist. Suspender straps (not shown) can thus be attached to front suspender release clips 120a and 120b, which are attached to suspender belt straps, 122a and 122b, which are attached to the belt 100. The suspender straps rest over the shoulders of the fisherman and lie across the fisherman's back where they meet rear suspender release clips, attached to rear suspender release straps.

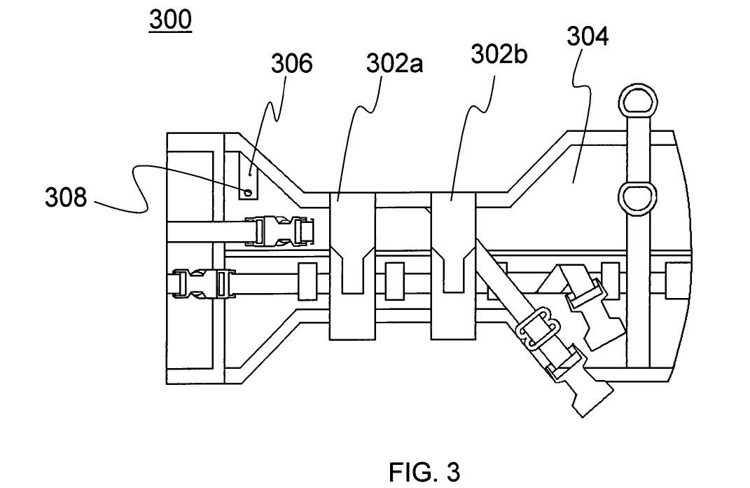

In FIG. 3, a tool compartment 302 is shown attached to the exterior 304 of the belt 300, and may be attached and detached from the belt 300 and configured to hold any type of hand tool to assist the user in fishing. The tool compartment 302 may be attached with the exterior 304 of the belt 300 by any desired mechanism, non-limiting examples including snaps, belt clips, standard size release clips, and Velcro™.

A tag clip 306 is also provided so that a user can store tags from or for fish for identification purposes. In one aspect, the tag clip 306 comprises a hook attached with the exterior portion 304 of the belt 300. In another embodiment, the tag clip 306 is a strap with a grommet 308 for hooking the tags onto the tag clip 306. The tag clip 306 may be attached by any desired mechanism, non-limiting examples including snaps, pins, standard size release clips, hooks, and Velcro™.

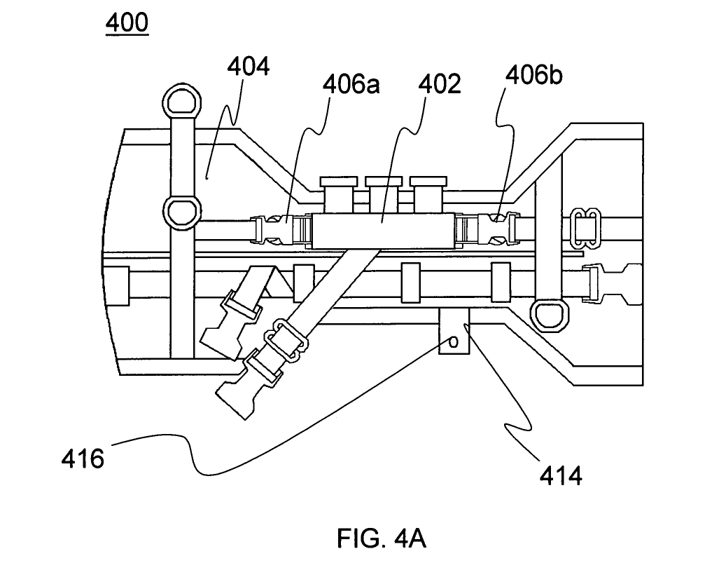

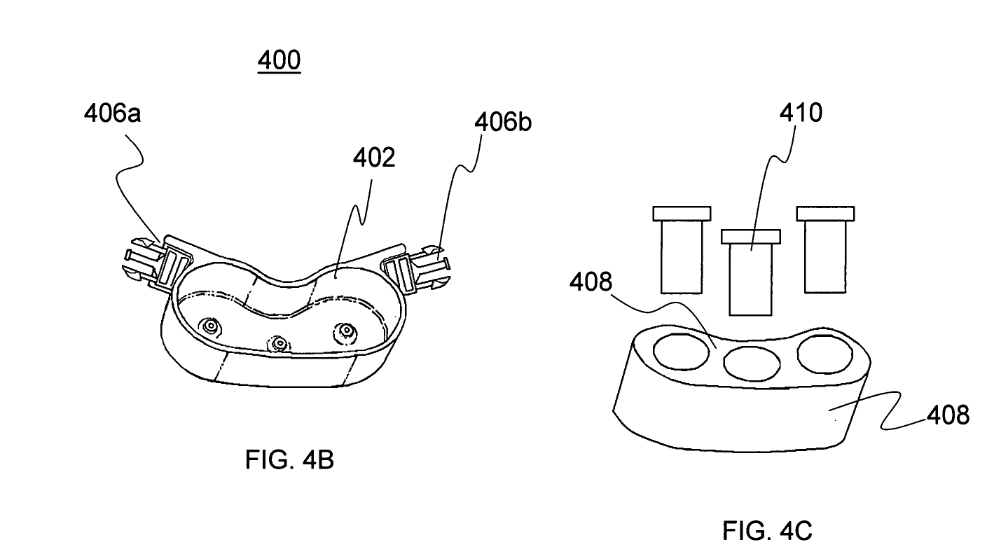

FIG. 4A also demonstrates how the belt 400 can also be configured to hold a variety of fishing accessories within a storage compartment 402 attached with the exterior portion 404 of the belt 400. The storage compartment 402 may be attached with the exterior 404 of the belt 400 by any desired mechanism, non-limiting examples of which include snaps, standard size release clips, hooks, and Velcro™. In the present embodiment, side clips 406a and 406b are used to attach the storage compartment 402 to the belt 400.

In FIG. 4B, the storage compartment 402 is shown in detail. The storage compartment 402 is made to hold a gasket 408, as illustrated in FIG. 4C. The gasket 408 may contain small cylindrical containers 410 which are separated by slabs of malleable material 412, a non-limiting example of which is silicone, to prevent movement of the small containers 410 with respect to the storage box 504.

FIG. 4A also depicts a towel holder 414 to allow the user to easily access a towel while fishing. The towel holder 414 is attached with the exterior 404 of the belt 400, and may, for example, consist of a curved hook attached with the exterior 404 of the belt 400. In another aspect, the towel holder 414 may comprise a strap with a grommet 416. The towel holder 414 may be attached by any desired mechanism, non-limiting examples including snaps, standard size release clips, belt clips, hooks, and Velcro™.

Also attached herewith is Appendix A, to be incorporated herein by reference in its entirety. Appendix A further describes alternative embodiments of the present invention that may be useful to one of ordinary skill in the art.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. A modular fishing belt for large game fishing, the belt comprising:
a belt portion for wrapping around a user's waist, the belt portion including a first end and a second end; where the belt includes an exterior portion, facing away from the user's body when the belt is secured, and an interior portion, facing toward the user's body when the belt is secured;
a fastener for fastening the first end to the second end to securely hold the belt about a user's waist;
a fastener for detachably attaching any type of front plate to allow a user to exchange different front plates to adjust for different fishing tasks, the front plate being attached to the exterior portion of the belt and positioned such that a user can rest a fishing pole in the front plate to distribute pressure therefrom about the user's thigh area; and
a fastener for detachably attaching any type of side plate to allow a user to exchange different front plates to adjust for different fishing tasks, the side plate being attached to the exterior portion of the belt and positioned such that a user can rest a fishing pole in the side plate to distribute pressure therefrom about the user's hip area.

24. A modular fishing belt as set forth in claim 23, wherein the fastener for fastening the first end of the belt to the second end of the belt is selected from the group consisting of a standard side release clip, D-ring, snap, hook, button, or Velcro™.

25. A modular fishing belt as set forth in claim 23, wherein the fastener for detachably attaching a front plate to the belt is selected from the group consisting of a standard side release clip, D-ring, snap, hook, button, or Velcro™.

26. A modular fishing belt as set forth in claim 23, wherein the fastener for detachably attaching a side plate to the belt is selected from the group consisting of a standard side release clip, D-ring, snap, hook, button, or Velcro™.

27. A modular fishing belt in accordance with claim 23, further comprising a fastener for detachably attaching a set of suspenders to the belt to rest over the shoulders and back of the user to assist in distributing pressure on the belt from the user's waist to the user's shoulders and back.

28. A modular fishing belt in accordance with claim 27, wherein the fastener for detachably attaching a set of suspenders to the belt is selected from the group consisting of a standard side release clip, D-ring, snap, hook, button, or Velcro™.

29. A modular fishing belt in accordance with claim 23, further comprising a storage compartment having an upper end with an opening, the storage compartment attached to the exterior portion of the belt.

30. A modular fishing belt in accordance with claim 29, further comprising a fastener for detachably attaching a storage compartment to the belt.

31. A modular fishing belt in accordance with claim 30, wherein the fastener for detachably attaching a storage compartment to the belt is selected from the group consisting of a standard side release clip, snap, hook, button, or Velcro™.

32. A modular fishing belt in accordance with claim 29, further comprising a substantially rigid gasket shaped to fit securely in the storage compartment.

33. A modular fishing belt in accordance with claim 32, wherein the gasket is made of aluminum.

34. A modular fishing belt in accordance with claim 32, further comprising a substantially rigid cylindrical member for placement in said gasket for storing individual items, the cylindrical member having a closure for sealing individual items in the cylindrical member.

35. A modular fishing belt in accordance with claim 34, further comprising at least one malleable slab made of silicon shaped to fit snugly in the gasket, the slab having spaces therein to snugly secure the cylindrical member such that the silicon slab prevents substantial movement of the cylindrical member with respect to the gasket.

36. A modular fishing belt in accordance with claim 23, further comprising at least one tool compartment detachably attachable with the exterior portion of the belt and having an opening with a closure mechanism, the tool compartment configured to hold a hand tool.

37. A modular fishing belt in accordance with claim 23, further comprising a fastener for detachably attaching the tool compartment with the exterior portion of the belt.

38. A modular fishing belt in accordance with claim 37, wherein the fastener for attaching the tool compartment to the exterior of the belt is selected from the group consisting of a standard side release clip, belt clip, snap, hook, button, or Velcro™.

39. A modular fishing belt as claimed in claim 23, further comprising, on the exterior portion of the belt, a means for attaching and detaching a towel to said modular fishing belt.

40. A modular fishing belt as set forth in claim 39, wherein the fastener for attaching and detaching a towel to the fishing belt is selected from the group consisting of a standard side release clip, belt clip, snap, hook, button, or Velcro™.

41. A modular fishing belt in accordance with claim 23 further comprising, on the exterior portion of the belt, a fastener for attaching and detaching identification tags to the belt, to be placed on a fish.

42. A modular fishing belt as set forth in claim 41, wherein the fastener for attaching and detaching identification tags to the belt is selected from the group consisting of a clip, pin, snap, hook, or Velcro™.

43. A modular fishing belt in accordance with claim 23, where the belt further comprises an interior portion, a top rim, and a bottom rim, the belt having a strip of material passed in the interior portion from the first end to the second end in a zig-zag manner alternating from about the top rim to the bottom rim, whereby the strip of material provides additional support for the belt.

44. A modular fishing belt for large game fishing, the belt comprising:
a belt portion for wrapping around a user's waist, the belt portion including a first end and a second end; where the belt includes an exterior portion, facing away from the user's body when the belt is secured, and an interior portion, facing toward the user's body when the belt is secured;
a fastener for fastening the first end to the second end to securely hold the belt about a user's waist; the fastener being selected from the group consisting of a standard side release clip, D-ring, snap, hook, button, or Velcro™
a fastener for detachably attaching any type of front plate to allow a user to exchange different front plates to adjust for different fishing tasks, the front plate being attached to the exterior portion of the belt and positioned such that a user can rest a fishing pole in the front plate to distribute pressure therefrom about the user's thigh area; the fastener selected from the group consisting of a standard side release clip, D-ring, snap, hook, button, or Velcro™
a fastener for detachably attaching any type of side plate to allow a user to exchange different front plates to adjust for different fishing tasks, the side plate being attached to the exterior portion of the belt and positioned such that a user can rest a fishing pole in the side plate to distribute pressure therefrom about the user's hip area; the fastener selected from the group consisting of a standard side release clip, D-ring, snap, hook, button, or Velcro™;
a fastener for detachably attaching a set of suspenders to the belt to rest over the shoulders and back of the user to assist in distributing pressure on the belt from the user's waist to the user's shoulders and back; the fastener selected from the group consisting of a standard side release clip, D-ring, snap, hook, button, or Velcro™;
a storage compartment having an upper end with an opening, the storage compartment attached to the exterior portion of the belt;
a fastener for detachably attaching a storage compartment to the belt, the fastener selected from the group consisting of a standard side release clip, snap, hook, button, or Velcro™;
a substantially rigid gasket shaped to fit securely in the storage compartment; wherein the gasket is made of aluminum;
a substantially rigid cylindrical member for placement in said gasket for storing individual items, the cylindrical member having a closure for sealing individual items in the cylindrical member;
a malleable slab made of silicon shaped to fit snugly in the gasket, the slab having spaces therein to snugly secure the cylindrical member such that the silicon slab prevents substantial movement of the cylindrical member with respect to the gasket;
a tool compartment detachably attachable with the exterior portion of the belt and having an opening with a closure mechanism, the tool compartment configured to hold a hand tool;
a fastener for detachably attaching the tool compartment with the exterior portion of the belt; wherein the fastener for attaching the tool compartment to the exterior of the belt is selected from the group consisting of a standard side release clip, belt clip, snap, hook, button, or Velcro™;
a fastener for attaching and detaching a towel to said modular fishing belt; wherein the fastener for attaching and detaching a towel to the fishing belt is selected from the group consisting of a standard side release clip, belt clip, snap, hook, button, or Velcro™;
a fastener for attaching and detaching identification tags to the exterior of the belt, to be placed on a fish; wherein the fastener for attaching and detaching identification tags to the belt is selected from the group consisting of a clip, pin, snap, hook, or Velcro™;
an interior portion, a top rim, and a bottom rim, the belt having a strip of material passed in the interior portion from the first end to the second end in a zig-zag manner alternating from about the top rim to the bottom rim, whereby the strip of material provides additional support for the belt.
